(19) United States
(12) Patent Application Publication
(10) Pub. No.: US 2004/0175299 A1
(43) Pub. Date: Sep. 9, 2004

(54) Microscale affinity purification system

(76) Inventors: Alexei Belenky, Newton, MA (US); Yuriy Dunayevskiy, Natick, MA (US); Dallas E. Hughes, Milford, MA (US)

Correspondence Address: WEINGARTEN, SCHURGIN, GAGNEBIN & LEBOVICI LLP, TEN POST OFFICE SQUARE, BOSTON, MA, 02109, US

(21) Appl. No.: 10/485,764

(22) PCT Filed: Aug. 5, 2002
(86) PCT No.: PCT/US02/24777

Related U.S. Application Data
(60) Provisional application No. 60/309,815, filed on Aug. 3, 2001.

(51) Int. Cl. G01N 27/453

(52) U.S. Cl. 422/101; 436/174; 204/451; 204/601

(57) ABSTRACT

A microscale affinity purification system has a plurality of capillary channels (100) which begin and end in common compartments (110, 120). An introduction cross-capillary channel (130) runs across the capillary channels (100) in a serpentine pattern (136, 138) near one end and a collection channel (140) similarly crosses the capillaries (100) in a serpentine pattern (148, 150) near the other end. A target molecule is introduced from a reservoir (132) which binds to a desired strong ligand in a sample in the capillaries (100). The target-strong ligand comlex migrates through the capillaries (100), is detected at a detector (146), and <collected in a collection reservoir (144).

### CROSS REFERENCE TO RELATED APPLICATIONS

This application claims the benefit under 35 U.S.C. §119(e) of U.S. Provisional Patent Application No. 60/309,815 filed on Aug. 3, 2001, entitled AFFINITY EXTRACTION OF LIGANDS FROM NATURAL SAMPLES ON A MICROSCALE FLUID HANDLING SYSTEM, the whole of which is hereby incorporated by reference herein.

### STATEMENT REGARDING FEDERALLY SPONSORED RESEARCH OR DEVELOPMENT

N/A

### BACKGROUND OF THE INVENTION

The isolation and characterization of potential drug lead compounds from crude natural extracts (e.g., fermentation broths, plant extracts, microbial extracts) is a complex and time-consuming procedure. This has led to a decreased interest by the pharmaceutical industry in pursuing natural products for new drug compounds. Once an extract containing a potential hit, or ligand, has been identified in a primary screen, the long, arduous task of isolating sufficient hit material for further characterization begins. Typically, this involves scale-up production of more extract (e.g., via fermentation or plant growth), followed by several cumbersome fractionation and purification steps. The isolation process can involve several sequential procedural steps such as liquid-liquid extraction, solid-phase extraction, countercurrent chromatography, and high performance liquid chromatography. With each fractionation step, material losses occur and thus, hit compounds in low concentration may be lost.

After sufficient hit compound has finally been isolated and purified, it is then typically subjected to structural analysis using a combination of techniques such as mass spectrometry (MS), nuclear magnetic resonance (NMR), and ultraviolet (UV) spectral analysis. The whole process can take weeks to months. An additional problem with natural product screening is that previously known, uninteresting compounds are often re-discovered through this process, resulting in a tremendous waste of time, money and resources. Thus, it is highly desirable to have a method that allows one to rapidly obtain enough information on an active hit compound to decide if it is worth further work.

Microfluidic devices and instrument miniaturization have experienced significant growth in development in response to the use of microchips as bioanalytical tools. However, the micro-analytical tools operate to separate particles of different types for an analysis of a sample being tested (i.e., qualitative analytical work) and not as a quantitative method to extract and isolate enough analyte for further characterization. Thus, one of the limitations of current capillary electrophoresis and other microfabricated chip-based systems for rapidly isolating a hit compound is obtaining enough hit compound to perform the subsequent structural and analytical work.

It would be useful not only to generate enough hit compounds for further analysis, but also to improve the efficiency and process of isolation and structural characterization of hit compounds in natural product extracts in the area of drug discovery. The present invention addresses these goals.

### BRIEF SUMMARY OF THE INVENTION

The invention is directed to a microfabricated, affinity purification system for the isolation of sufficient quantities of hit compounds for subsequent characterization. The microscale affinity purification system of the invention comprises a plurality of capillary channels, which begin and end in common compartments, complexed into an array. The channels within the system have substantially identical, optimal dimensions of cross-section and length. These channels are integrally connected to one common detection point and one common collection channel that may be operably connected to, e.g., a capillary electrophoresis—mass spectrometry interface. In one aspect, at one end, the capillary channels of the invention are interfaced to an introduction serpentine channel that runs across all channels. In another aspect, at the other end, the channels are again interfaced to a collection serpentine channel that runs across all channels, wherein the collection serpentine channel is connected to at one end a buffer reservoir and at the other end a collection reservoir.

### BRIEF DESCRIPTION OF THE FIGURES

Other features and advantages of the invention will be apparent from the following description of the preferred embodiments thereof and from the claims, taken in conjunction with the accompanying drawings, in which:

FIG. 1 shows an electrophoretic migration of the target, hit and target/hit complex;

FIG. 2 shows a schematic of the microscale affinity purification system of the invention;

FIG. 3 shows a single channel microscale affinity purification system of the invention;

FIG. 4 shows the positioning of the electrodes from a power source;

FIG. 5 shows a schematic of the microscale affinity purification system of the invention including an exemplary analysis system for the target/strong hit complex;

FIG. 6 is a top view of a microscale affinity purification system;

FIG. 6A is a partial top view at detail A of a collection end of the affinity purification system of FIG. 6;

FIG. 6B is a partial top view at detail B of an introduction end of the affinity purification system of FIG. 6;

FIG. 6C is a partial top view of a portion of an introduction cross-capillary channel;

FIG. 6D is a partial top view of a portion of a collection cross-capillary channel;

FIG. 7A is an isometric view of the affinity purification system;

FIG. 7B is a partial isometric view of detail F of an introduction cross-capillary channel of the affinity purification system of FIG. 7A;

FIG. 7C is a partial isometric view of detail E of a collection cross-capillary channel of FIG. 7A;

FIG. 7D is a partial isometric view of the collection end of the affinity purification system of FIG. 7A;

FIG. 8 is an isometric view of the microscale affinity purification system of the invention showing a covering substrate; and

FIG. 9 is an isometric view of the assembled microscale affinity purification system of the invention.

### DETAILED DESCRIPTION OF THE INVENTION

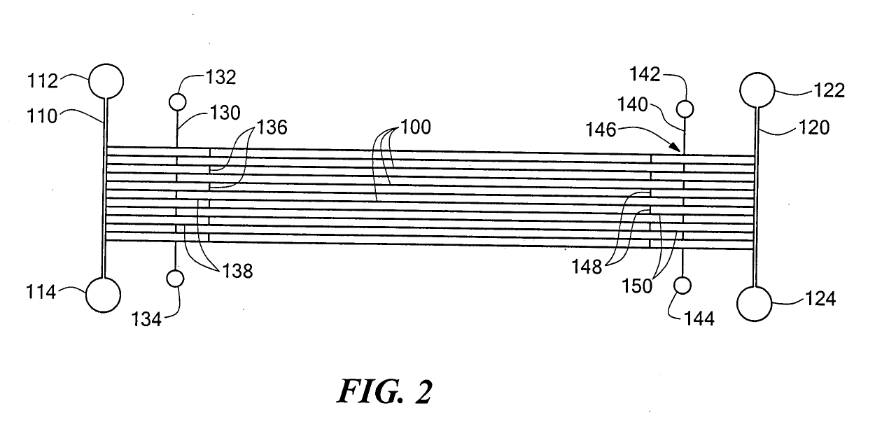

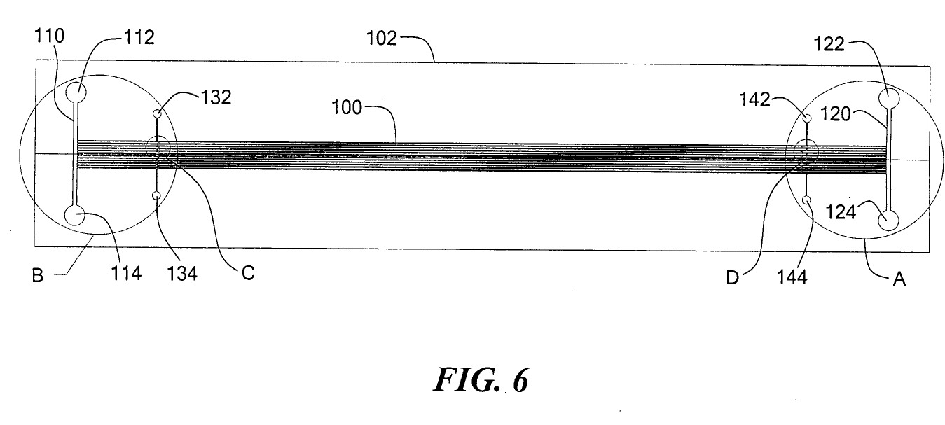

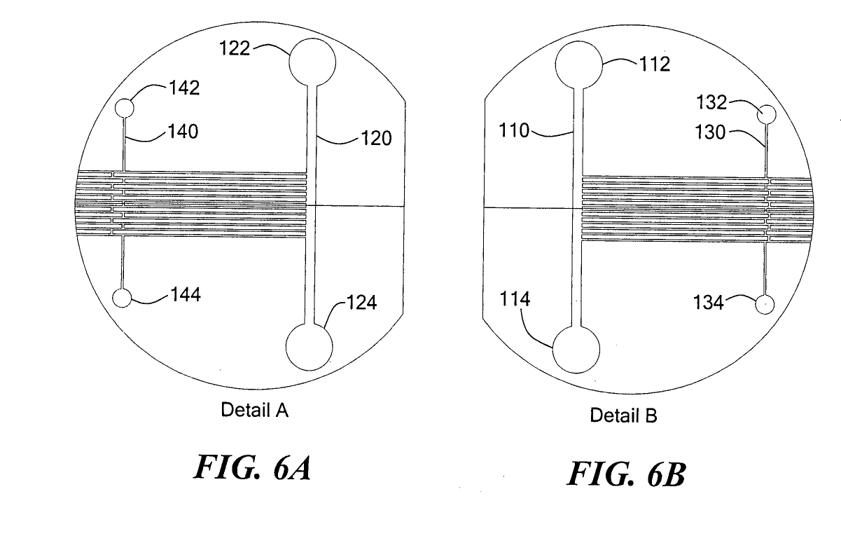

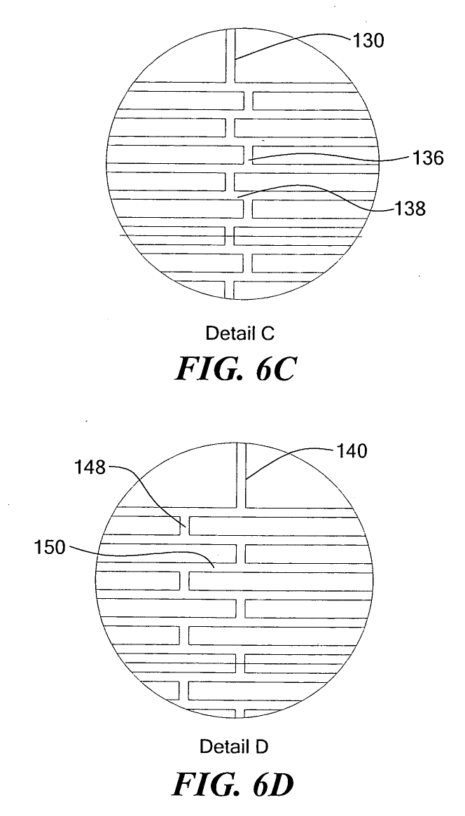

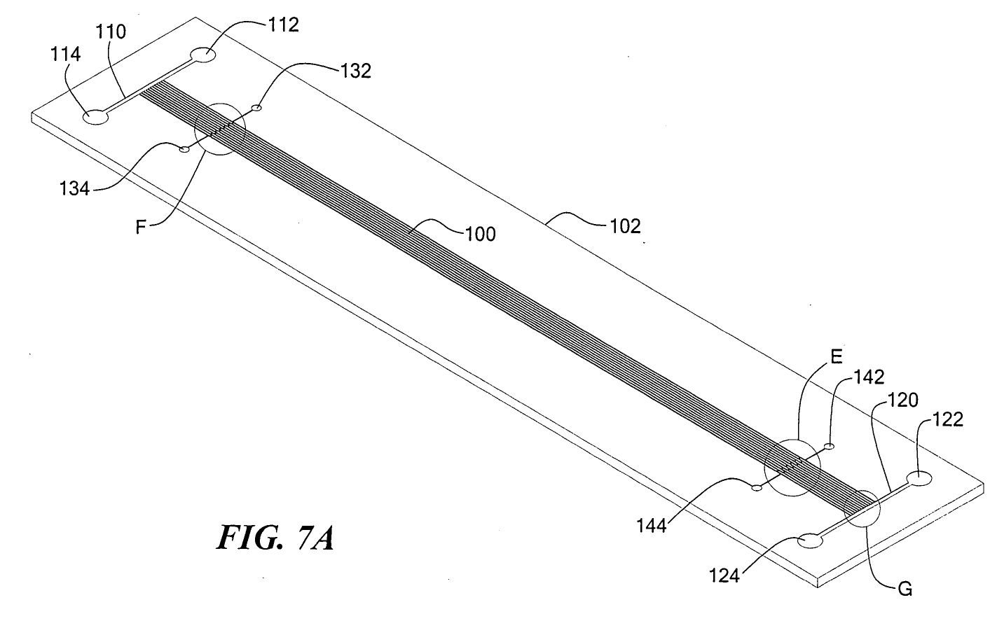

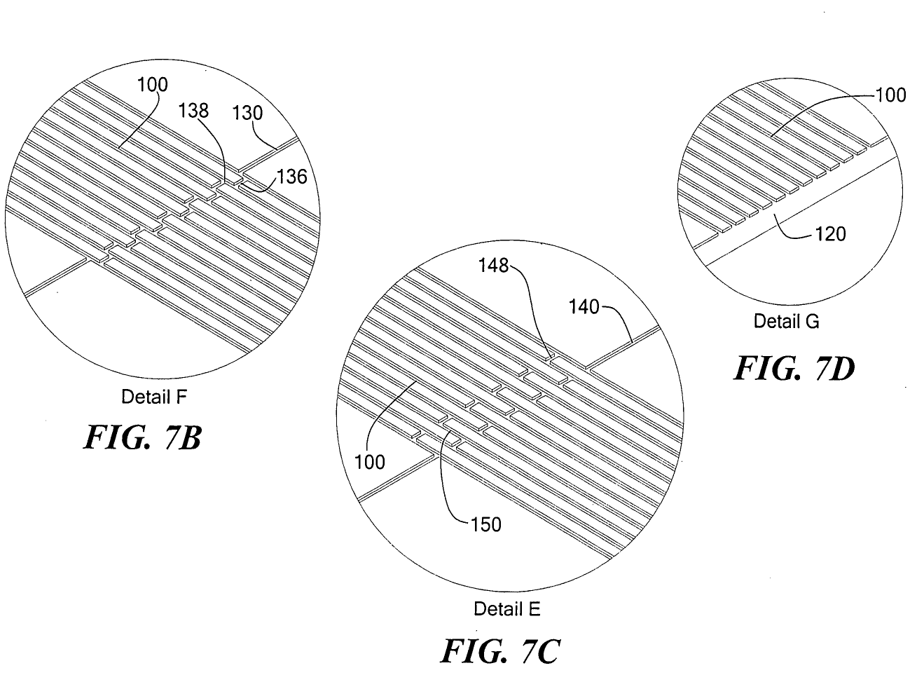

This invention relates to a microscale affinity purification system to extract strong affinity compounds from a natural sample (NS). Referring to FIG. 2, the affinity purification system has multiple parallel capillary channels 100 formed in a substrate 102 (see FIGS. 6 and 7). An introduction cross-capillary channel 130 is formed in the substrate near one end, an introduction end, of the substrate, and a collection cross-capillary channel 140 is formed in the substrate near the opposite end, a collection end, of the substrate. The introduction and collection cross-capillary channels intersect the multiple parallel capillary channels 100 in a serpentine configuration, described further below.

The system and method of the present invention use the principle of affinity concentration of a strongly bound ligand present in the natural sample by a protein target. Typically, but not always, ligands of a particular binding strength have certain similar characteristics. “Moderate-to-strong binding” ligands (MTBL) and “weak-binding” ligands have faster off-rates (K_{off}) and higher dissociation constants (K_{D}) than “strong-binding” ligands and form target/ligand complexes that will not accumulate in the target zone during electrophoresis. In contrast, strong-binding ligands have lower dissociation constants and slower off-rates, forming stable target/ligand complexes that remain bound to the target and accumulate in the target zone during electrophoresis as they migrate past a detector during capillary electrophoresis. General characteristics of these ligand groupings are outlined in Table 1.

TABLE 1

| | Approx. | Approx. |
|---|---|---|
| Ligand | K_{D} range | K_{off} range |
| Strong - | <100 nM | <0.01 |
| binding | | (s⁻¹) |
| Moderate-to- | 100 nM-1 μM | 0.01-0.1 |
| strong- | | (s⁻¹) |
| binding | | |
| Weak-binding | >1 μM | >0.1 |
| | | (s⁻¹) |

Natural samples including, but not limited to, any pure, partially pure, or impure sample that contains complex biological material are considered appropriate samples to be analyzed by the method of the invention. “Complex biological material” is intended to include any mixture of compounds that may contain compounds that are potentially useful in a biological system, e.g., whether human, other mammalian, or agricultural. For example, large chemical libraries are frequently generated by combinatorial chemistry to enable investigators to screen extremely large numbers of chemical compounds for potential therapeutic or diagnostic purposes. These libraries can be, in essence, modified biological scaffolds and can be screened advantageously by the method of the invention. Particularly suitable as exemplary natural samples are extracts of terrestrial and marine plants, cells from higher animals including humans, eubacteria, actinomycetes and other bacteria, extracts from non-recombinant or recombinant organisms, microbial fermentation broths, both filamentous and non-filamentous fungi, protozoa, algae, archaebacteria, worms, insects, marine organisms, sponges, corals, crustaceans, viruses, phages, tissues, organs, blood, soil, sea water, water from a fresh-water body (e.g., lake or river), humus, detritus, manure, mud, and sewage or partially pure fractions from isolation procedures performed on any of these samples (e.g., HPLC fractions).

The natural sample may be one that is harvested from the environment and/or cultured under suitable environmental conditions (growth medium, temperature, humidity). Preferably, the harvested sample is simply diluted to the extent necessary to practice the method of the invention. However, if necessary, the sample material can be treated by any combination of standard processes used by those skilled in the field to prepare the sample for analysis. For example, the crude sample may be subjected to a preliminary treatment such as freeze-thawing, homogenization, sonication, heating or microwave extraction to break down cell walls. The sample could be heated at, e.g., 50° C. for 10 minutes to inactivate destructive enzymes. Non-specific proteins may be added to prevent destruction of proteinaceous targets by heat-resistant proteases. Extraction of cells or culture media with various solvents—such as ethyl acetate, dimethylsulfoxide, ethanol, methanol, ether or water—can be carried out, followed by filtration to remove particulate matter and/or high molecular-weight compounds. The natural sample may also be fractionated by centrifugation, sequential extractions, high pressure-liquid chromatography, thin-layer chromatography, counter-current chromatography, and/or other chromatography techniques before use in the method of the invention. Various fractions of a positive sample may be tested to help guide the detection and isolation of active compounds by the method of the invention.

Finally, the sample may be diluted in aqueous or non-aqueous solution prior to addition to the running buffer, which may contain salts and buffers such as sodium chloride, sodium citrate or Good's biological buffers. Additional dilution factors may be desirable.

Due to the high resolving power of capillary electrophoresis (CE), the target sample may be purified, partially purified, or even unpurified (e.g., as in a bacterial extract), as long as the target and/or ligand/target complex give(s) a discernible CE peak. Any molecule that is implicated in a disease process is a potential target. Furthermore, the potential target may be any molecule useful in diagnosing a specific condition. Additionally, other categories of target molecules can be contemplated. For example, in the agricultural arena, the target could be a molecule representing an essential function of an insect pest. Examples of target molecules that may be used in the method of the invention include: proteins, nucleic acids, carbohydrates, and other compounds. Some examples of therapeutic target molecules are included in Table 2:

TABLE 2

| Molecular Target | Associated Disease(s) |
|---|---|
| HIV reverse transcriptase | AIDS |
| HIV protease | AIDS |
| Carbonic anhydrase | Glaucoma |
| Tubulin | Cancer |
| Thrombin | Blood clots |
| HMG-CoA reductase | High cholesterol |
| Elastase | Emphysema, |
| | Rheumatoid arthritis |
| Cyclooxygenase | Inflammation |
| p56, p59 tyrosine kinases | Cancer |
| Topoisomerases | Cancer |
| Dihydrofolate reductase | Cancer |

Other examples of appropriate molecular targets include DNA or RNA (used to search for nucleic acid-binding proteins, transcription factors, etc.) ribosomes, cell membrane proteins, growth factors, cell messengers, telomerases, elastin, virulence factors, antibodies, replicases, other protein kinases, transcription factors, repair enzymes, stress proteins, uncharacterized disease-related genes and/or their RNA and protein products, uncharacterized disease-related regulatory DNA or RNA sequences, lectins, hormones, metabolic enzymes, proteases and toxins. This definition also includes any subcomponent of the listed molecules, such as protein subunits, active peptide domains of therapeutic proteins and active regions of small molecules. The target molecule may be chemically, enzymatically, or recombinantly altered to improve its electrophoretic properties (e.g., deglycosylated) or subjected to fluorophore or polyion addition to facilitate its separation and/or detection during CE.

The target should be detectable during capillary electrophoresis. For instance, it may be detectable by observation of its ultraviolet (UV) or other light absorbance properties, or its fluorescence properties. One may label the target with a detectable tag, such as a tag of a fluorescent or other dye, a radio-label, a chemical tag or other marker. For example, a fluorescently labeled target may be detected by ultraviolet light absorption detection (typically having a micromolar detection limit) or, more preferably, by laser-induced fluorescence detection (typically having a picomolar to low nanomolar detection limit). An additional advantage of a fluorescent tag is the selectivity provided, particularly in complex samples that may have many UV-absorbing compounds present. The need for a detectable tag, and the type used, will depend on the nature of the target molecule.

Proteins and peptides may be labeled by, e.g., amino labeling of lysine residues or sulfhydryl labeling of cysteine residues. Nucleic acid species and polynucleotides may be labeled by incorporating a labeled nucleotide in an in vitro synthesis reaction. Methods of labeling various targets are well-known in the art.

If desired, one may confirm prior to practicing the method of the invention that a modified target, e.g., a fluorescently labeled target, retains its functional activity. That is, one can confirm that the labeled target retains a functionally active site by using any available, well-established functional or binding assay whose result depends on a functionally active target.

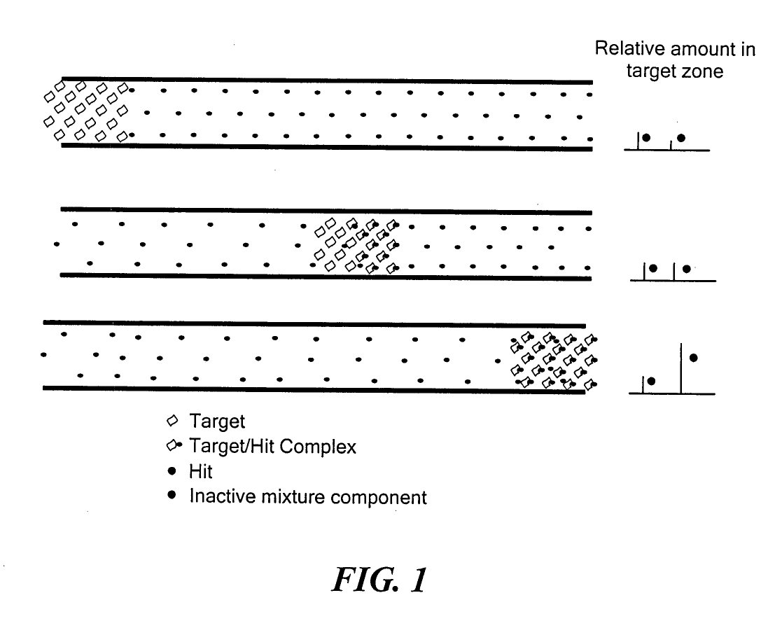

In the method of the invention, all the channels of the device are first filled with a running buffer containing a selected NS with the hits to be collected. Referring to FIG. 1, which illustrates the process in a single channel at different time points, a target sample is introduced into the capillary channel either by electrophoresis or pressure. The target is then electrophoresed through the running buffer containing NS and any strong hits in a direction from the introduction end to the collection end. The target binds to any strong hits as it migrates through the NS-containing running buffer. In the vicinity of the target sample, the protein zone, the concentration of the target protein is usually greater than the concentration of the hit (e.g., 5 μM of target protein and 1 nM of strong hit). Thus, only a small portion of the target binds the strong hit at any particular moment in time during the migration. The excess concentration of the target protein drives the equilibrium toward complex formation. As the protein zone continues migrating, remaining free or unbound target protein is exposed to a new portion of strong hit in the buffer. Consequently, more protein/strong hit complex forms as the electrophoretic migration proceeds. As a result of these multiple events, the strong hit will be concentrated in the electrophoretic zone containing the target protein and thus, affinity extracted from the NS by the target (FIG. 1). Near the collection end, the presence of target/hit complex is detected by a suitable detector near the collection cross-capillary channel, and electrophoresis along the capillary channels is stopped once the target is within the serpentine collection cross-capillary channel. The target/hit complex is collected via the collection cross-capillary channel.

A weak hit, if present in the same NS, will not be concentrated with the target protein during the electrophoretic run. Any weak hit/protein complex dissociates due to the fast kinetics (off-rate) of the weak hit. The concentration effect of a strong hit also allows for better competition of strong hit for binding in the presence of a weak hit compared to the binding performed under equilibrium conditions in a vessel.

The capillary channels of the microscale affinity purification device can have one detection point and one collection point where a strong hit/target complex is collected for further analysis, e.g., on-line CE-MS or off-line mass spectrometric analysis, affinity CE experiments, liquid chromatography/mass spectrometry, nuclear magnetic resonance (NMR), biological assays, biochemical assays. The detection of the target can be placed along any of the capillary channels. Preferably, the detection is near the collection channel of the invention to be confident that the protein zone is within the collection channel when electrophoresis is stopped. The use of a multiple channel affinity purification system allows for ease of sample manipulation and concentration of the strong hit from multiple electrophoretic channels into one collection point.

The described procedure results in the isolation of a strong hit from natural samples by affinity extraction using the microscale affinity purification system of the invention. The strong hit must have a high affinity to a target (e.g., K_{d}<100 nM) in order to be concentrated with the target in the electrophoretic zone.

Referring to FIGS. 6-7D, the plurality of microchannels 100 is formed in any suitable manner in the substrate 102. The substrate is made of a non-conductive material, such as, but not limited to, silicon (such as a silicon wafer), polysilicon, borosilicate glass, quartz, polymeric materials (organic or inorganic), polymethyl methyl acrylate (PMMC), polydemethylsilaxone (PDMS), or polycarbonate. All channels of the invention can be made using microfabrication techniques, for example, photolithography and wet chemical etching, or other microelectromechanical systems technologies (e.g., dry etching, laser ablation, injection molding, embossing, stamping). The channels may also be coated with a hydrophilic polymer to reduce the electroosmotic flow and prevent adsorption of analytes onto the walls of the capillary and cross-capillary channels.

Generally, the structure of the microscale affinity purification system of the invention may have different configurations and dimensions as will be appreciated by one of ordinary skill in the art. For example, the capillary channels may have different arrangements and designs. However, the dimensions must be such that excessive voltage would not adversely affect the conditions of the electrophoresis assay. With electrophoresis, for example, the voltage should be in the range of about 0.5 to 30 kilovolts. The following are exemplary dimensions that provide operative structural conditions. The thickness of the capillary channel substrate 102 ranges from 1 to 2 mm. The capillary channels 100 are preferably aligned in parallel and have equal cross-sectional areas and lengths. The length may range from 10 to 100 cm, the depth may range from 10 to 100 μm, and the width may range from 50 to 200 μm. In one suitable embodiment, the microchannels have a length of 20 cm, a depth of 60 μm, and a width of 120 μm, which can accommodate 1.44 μL volume in a capillary channel. The number of capillary channels 100 in the microscale affinity purification system of the invention may range from two to more than 300 channels, preferably, a maximum of 200 channels. The number of capillary channels is dependent on the size of the overall microfluidic device. The capillary channels 100 accommodate a total volume of 100 to 2000 μL, preferably 500 μL. The spacing between the capillary channels 100 is from 20 to 200 μm.

A common cross-capillary channel 110 is provided at a first end for analyte communication with the capillary channels 100, and a common cross-capillary channel 120 is provided at a second end for analyte communication with the capillary channels 100. The analyte according to the invention can be any molecule, including, e.g., natural sample, target protein, a hit compound, or a ligand. First and second inlet reservoirs 112, 114, 122, and 124 are provided at the ends of the common cross-capillary channels 110, 120, to facilitate filling the capillary channels 100 with the running buffer and for possible electrode placement. Alternatively, any one or two of the reservoirs 112, 114, 122, and 124 may be used to fill all of the capillary channels. To practice the invention, for example, reservoirs 112, 114 and common cross-capillary channel 110 is filled with buffer. Once the buffer fills the capillaries 100, then the reservoirs 122, 124 and the common cross-capillary channel 120 can be refilled with buffer.

The common cross-capillary channels 110 and 120 provide inlets that evenly distribute the running buffer throughout the capillary channels 100. Any remaining running buffer in the reservoirs may be removed by, for example, vacuum or pressure if desired. The common cross-capillary channels 110 and 120 and their corresponding reservoirs accommodate a total volume of 0.5 to 2 ml, preferably 0.5 ml. For each common cross-capillary channel 110 and 120, the capillary channel depth may be 10 to 100 μm, preferably 60 μm; the common cross-capillary channel 110 and 120 width may be 0.5 to 2 mm, preferably 1 mm; and the common cross-capillary channel 110 and 120 length may be 10-40 cm, preferably 20 cm, but, this is dependent on the number of capillary channels desired.

As noted above, the introduction and collection cross-capillary channels 130 and 140 have a serpentine configuration. Portions 136 and 148 of the cross-capillary channels 130 and 140 between adjacent capillary channels 100 extend transversely to the capillary channels 100. Alternate portions 138 and 150 of the cross-capillary channels 130 and 140 coincide with portions of the capillary channels 100. See, for example, FIGS. 6C, 6D, 7B, and 7C. The coinciding portions of the introduction and collection cross-capillary channels 130 and 140 ensure that a sufficient volume or amount of the target protein is introduced into each capillary channel 100 simultaneously, both at the introduction end and the collection end. The first end of the coinciding portion 138 of the introduction cross-capillary channel 130 is approximately 0.5-2 cm away from the common cross-capillary channel 110. The closest end of the coinciding portion 150 of the collection cross-capillary channel 140 is approximately 0.5-2 cm from the common capillary channel 120. The length between the introduction cross-capillary channel 130 and the collection cross-capillary channel 140 should be sufficient enough to accommodate an optimal total volume. This provides an appropriate accumulation of target/ligand complexes. For example, the minimal length from the introduction cross-capillary channel 130 to the collection cross-capillary channel 140 is at least about 2 cm. In a linear configuration of the capillary channels 100, however, the length of the introduction cross-capillary channel 130 to the collection cross-capillary channel 140 has a maximum length of 100 cm. One of ordinary skill in the art can appreciate that other configurations may be used where the length can be as long as 1 m.

The introduction cross-capillary channel 130 has at both ends reservoirs 132 and 134. Reservoir 132 is used to facilitate the addition of the target protein. Reservoir 134 is used to collect any residual flow of target protein after the entire introduction cross-capillary channel 130 is filled with the target. The collection cross-capillary channel 140 also has at both ends reservoirs 142 and 144. Reservoir 142 provides a buffer reservoir for electrophoresis. Reservoir 144 provides a collection reservoir of the target/strong hit complex for further analysis and separation of the hit (ligand).

The cross-capillary channel 130 is a target (protein) introduction serpentine cross-capillary channel that can range from 10 to 100 μm in depth, preferably 60 μm in depth, and 50 to 200 μm in width, preferably 120 μm. The introduction cross-capillary channel 130 also has introduction reservoirs 132 at one end.

Similarly, approximately 0.5-2 cm away from the common capillary channel 120 is a collection serpentine cross-capillary channel 140 with collection reservoir 144 at one end of the cross-capillary channel and a buffer reservoir 142 at the other end. The serpentine collection cross-capillary channel 140 can have a range from 10 to 100 μm in depth, preferably 60 μm; and a range from 50-200 μm in width, preferably 120 μm.

As shown in detail in FIGS. 6-6D, the common capillary channel 110 with reservoirs 112 and 114 are depicted in common to the capillary channels 100 (shown in greater detail in FIG. 6B). An enlarged view of the serpentine configuration (FIG. 6C) of the introduction cross-capillary channel 130 details a shorter horizontal serpentine distance that coincides with the capillary channels 100 as compared to that of the serpentine configuration (FIG. 6D) of the collection cross-capillary channel 140. While the length of the coinciding portion of the introduction and the collection cross-capillary channel may be identical, it is preferred that the coinciding portion in the collection cross-capillary channel 140 be longer than the coinciding portion in the introduction cross-capillary channel 130 due to diffusion of the target during electrophoresis. A longer length would allow for the appropriate accumulation of the diffused target/ligand complex for collection.

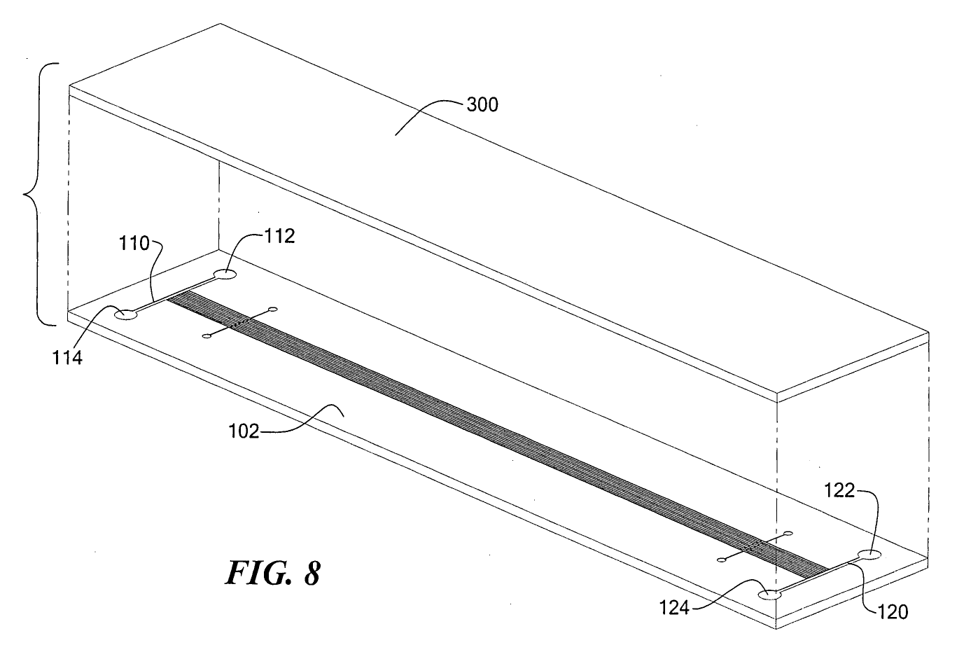

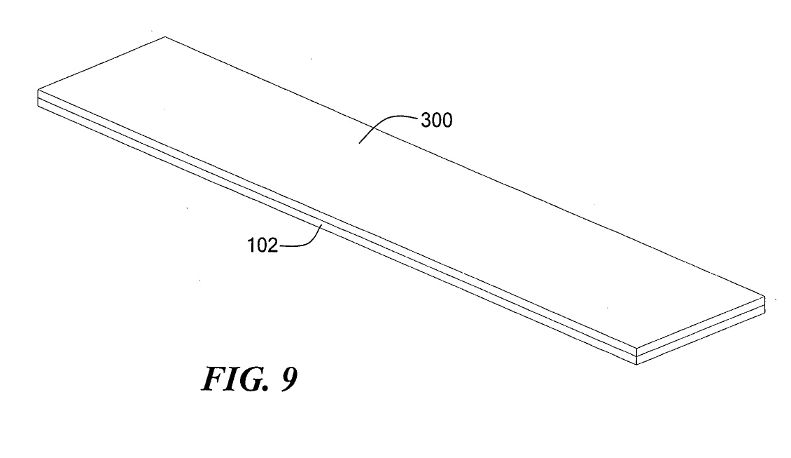

A covering or a sealing substrate 300 is placed over the capillary channel substrate as shown in FIGS. 8 and 9. This substrate seals the enclosed microchannels. The covering substrate 300 may comprise a silicone elastomer or other transparent plastic polymer that is non-conductive. However, a covering substrate is not necessary if the multiple capillary device of the invention is manufactured by boring through a substrate.

The microscale affinity purification system of the invention can be used at temperature ranges from 5° to 45° C., preferably 20° C.

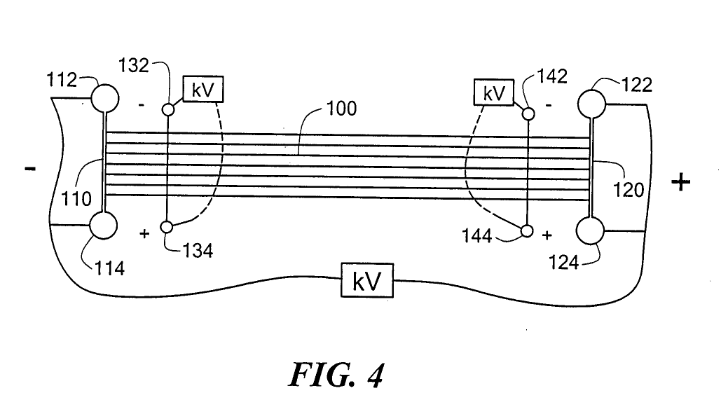

As shown in FIG. 4, various electrodes may be placed accordingly for the electrophoretic operation of the microscale affinity purification system. Used conventionally in the art, the electrodes may comprise, e.g., platinum wires. Through electrodes placed in reservoirs 112, 114, 122 and 124, a potential difference is applied across microchannels 100. Electrodes placed in reservoirs 132 and 134 apply a potential difference across the introduction cross-capillary channel 130. Electrodes placed in reservoirs 142 and 144 provide a potential difference across the collection cross-capillary channel 140. Depending on the surface properties of the channel (whether negatively or positively charged), the larger voltage must be applied to the appropriate reservoir, such that eluent migration will have the desired direction. Depending on the length of the microchannels and the desired migration rate and pressure, the necessary voltage drop for its operation may vary from a few tens to thousands of volts (e.g., 0.5 kV/cm).

In operation, the microscale affinity purification system of the invention is activated by introducing into one of two of reservoirs 112, 114, 122, and 124 a buffer or solvent so that all the capillary channels 100 and either channel 110 or 120 can be filled with a buffer containing natural sample (NS). The NS concentration in the running buffer may range from 0.01-2 mg/ml, preferably 1 mg/ml. The capillary channels 100 are then filled by capillary action, vacuum for 1-2 minutes, or by pressure differential.

Once the entire NS buffer is filled into the microchannels 100, a sufficient amount of target (protein) is added to reservoir 132. The protein concentration may range from 0.1-50 μM, preferably 5 μM. The undesired migration of the target away from the serpentine introduction cross-capillary channel 130 into the capillary channels 100 can be prevented by removing all buffer from common capillary channel 110 and 120 or by adding a non-conductive material to prevent current flow to common capillary channel 110 and 120. After adding the target to reservoir 132, electrophoresis is started along the introduction cross-capillary channel 130 to fill the introduction cross-capillary channel 130 with the target. With pressure or vacuum application, the buffer and natural sample components will be pushed forward in the coinciding portion of the capillary channels. When an electrophoretic introduction of the target is used, there may be buffer and uncharged neutral products components remaining in the channel 130. When an electrophoretic introduction of the target is used, a potential may need to be applied along the collection cross-capillary channel 140 to eliminate an electric field gradient along the capillary channels 100 between the introduction cross-capillary channel 130 and the collection cross-capillary channel 140. This may also prevent any target from migrating out of the coinciding portions 138 of the introduction cross-capillary channel 130 into adjacent portions of the capillary channels 100 during the loading of the target. Also, mechanical isolation of 130 or 140 can be achieved by physical pressure using the covering substrate if made of a suitably elastic material, such as PDMS.

Electrophoresis is applied along capillary channels 100 to allow the target to migrate across and to the detection point 146. Exemplary detection methods applicable include, but are not limited to, laser-induced fluorescence (LIF) and ultraviolet (UV) light detection. When the target zone reaches serpentine collection cross-capillary channel, as determined using detector 146, the electrophoresis is turned off along the capillary channels 100 and electrophoresis is then turned on along the collection cross-capillary channel 140. The target and the target/strong hit complex will then migrate into the collection reservoir 144. Pressure or vacuum may also be used here as with the target injection.

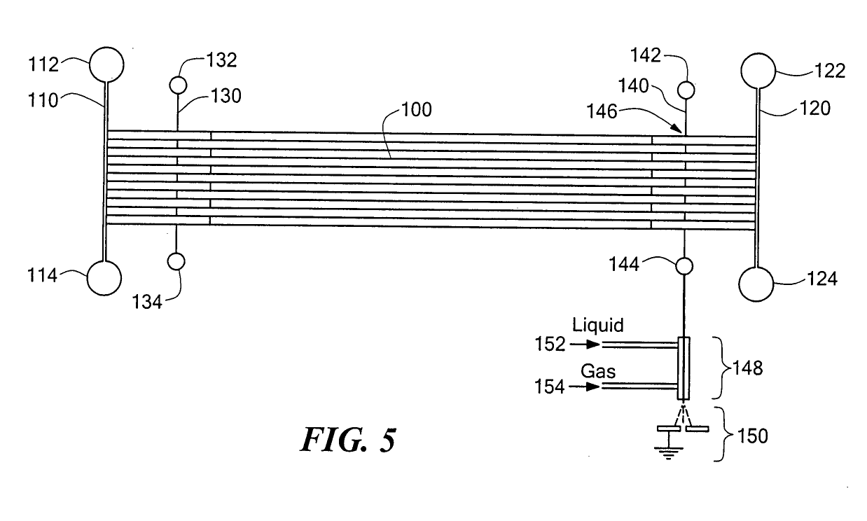

As further shown in FIG. 5, after the target/strong hit complex migrates into the collection reservoir 144, further analysis may be performed by a number of possible methods, e.g., on-line capillary electrophoresis-mass spectrometer (CE-MS) interface 148 or an off-line mass spectrometry 150. Others include, but are not limited to, affinity CE experiments. Further analysis may include liquid chromatography (LC)-MS analysis where the strong hit is separated from the target on reversed phase high performance liquid chromatography (HPLC) column and identified on-line using a mass spectrometer. Use of a C₁₈ HPLC column and acidified mobile phase will assist complex dissociation during HPLC separation. Alternatively, the target/strong hit complex is analyzed by CE-MS interfaced on-line with multichannel device or used in off-line mode. In this case, target/strong hit complex will be separated from any background from the natural sample components collected in the collection reservoir 144. A liquid sheath 152, often used in a CE-MS interface and consisting of organic solvent (e.g., 50% methanol) and organic acid (e.g., 1% acetic acid), will assist complex dissociation and identification of the strong hit by mass spectrometry.

In another approach, one can utilize an ultrafiltration device. The target and target/strong hit complex are collected on a multichannel device and mixed with a solution consisting of organic solvent and organic acid to induce complex dissociation. The reaction mixture is then introduced onto the surface of the ultrafiltration device with a low molecular weight cut-off filter (e.g., 3,000 Da). A dissociated small molecular weight strong hit passes through the membrane and is separated from the high molecular weight (e.g., >3,000 Da) target. The purified strong hit is then used in mass spectrometer analysis for molecular weight identification and other secondary assays to establish the potency of the extracted compound.

In a suitable exemplary embodiment, a microscale affinity purification system of the invention may comprise 200 capillary channels with a capacity of 288 μL volume (1.44 μL per capillary channel) having dimensions of 60 μm (depth)×120 μm (width)×20 cm (length). 1 mg/mL natural sample (NS) in running buffer (RB) is added to all reservoirs. Electrophoresis is applied across the running buffer channels to allow the buffer to be filled into all the channels. Any remaining running buffer in the reservoirs is removed and voltage is no longer applied. Target with a concentration of 5 micromolar is added to the introduction reservoir, where voltage is then applied across the introduction cross-capillary channel to fill the serpentine introduction cross-capillary channel 130 with the target. The NS in the assay can be about 1 mg/mL and the hit compound (ligand) in the assay may be about 10 ng/mL. The volume of target introduced into each channel is about 10 nL, which can contain about 10⁻⁵ micromoles of target (based on a 30 kDa target) in the affinity purification system of the invention. In this case, the maximum amount of strong hit/target complex that can be concentrated is 10⁻⁵ micromoles (assuming a one-to-one binding stochiometry, and if all the target is bound to the hit). This corresponds to about 5 ng of hit material (assuming 500 Da MW) that will be collected in 10 μL of volume in the collection reservoir 144. This results in a hit concentration of about 0.5 μg/mL or 0.5 μM, which would be enough for several types of follow-on tests, including mass spectrometry identification.

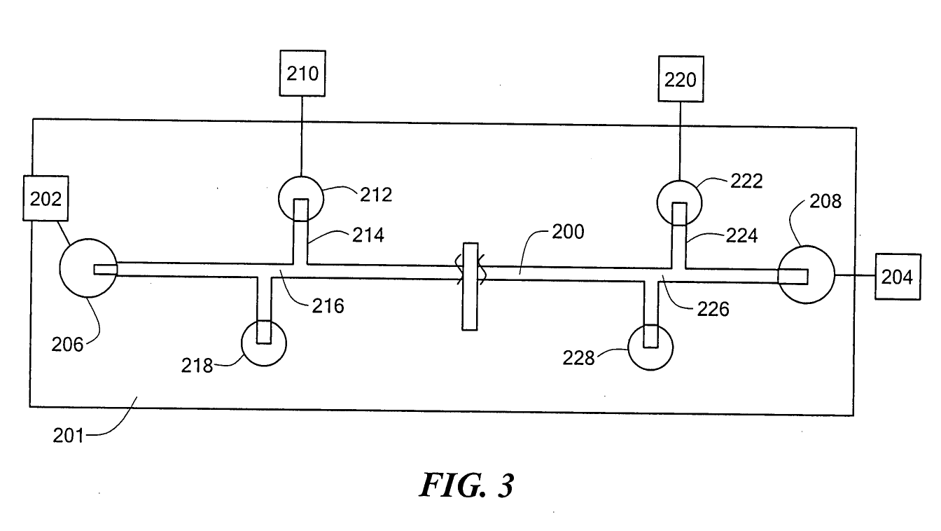

In an alternative embodiment, as shown in FIG. 3, a single capillary channel device is illustrated. A longitudinally extended, single capillary channel 200 is provided in a substrate 201. A first source of buffer 202 is provided for analyte connection to one end of the channel. A second source of buffer 204 is provided for analyte connection to the opposite end of the channel. Reservoirs 206 and 208 are provided at the ends of the channel to receive buffer from sources 202 and 204, respectively. Reservoirs 206 and 208 can also contain electrodes for, for example, electrophoresis. A target source 210 is provided for analyte communication with a target reservoir 212 disposed at one end of an introduction cross-capillary channel 214 formed in the substrate and extending across the capillary channel 200 near the reservoir 206. At least a portion of the introduction cross-capillary channel 214 has a coinciding portion 216 that coincides with the capillary channel 200. A second target reservoir 218 is also disposed at one opposite end of the introduction cross-capillary channel 214 to receive excess target.

Near the reservoir 208 is a collection cross-capillary channel 224 formed in the substrate, which extends across the capillary channel 200. A buffer source 220 is provided for analyte communication with a buffer reservoir 222. The buffer reservoir 222 is disposed at one end of the collection cross-capillary channel 224. At least a portion of the collection cross-capillary channel comprises a coinciding portion that coincides with a portion of the capillary channel 200. A collection reservoir 228 is disposed at an opposite end of the collection cross-capillary channel 224 to receive target/ligand complex.

The capillary channel 200, the introduction cross-capillary channel 214 and the collection cross-capillary channel 224 each comprise an analyte movement system operative to move analyte along the channels. The analyte movement system can be an electrophoresis system to provide a voltage differential across the channels. Operation of the single channel device is substantially as described above with respect to the multiple capillary device.

While the present invention has been described in conjunction with a preferred embodiment, one of ordinary skill, after reading the foregoing specification, will be able to effect various changes, substitutions of equivalents, and other alterations to the compositions and methods set forth herein. It is therefore intended that the protection granted by Letters Patent hereon be limited only by the definitions contained in the appended claims and equivalents thereof.

What is claimed is:

1. A microscale affinity purification system comprising:
a substrate;
a plurality of longitudinally extending capillary channels formed in the substrate, the capillary channels connected at one end to a first common source and connected at an opposite end to a second common source;
a first analyte movement subsystem operative to move analyte along the plurality of capillary channels from the first common source to the second common source or from the second common source to the first common source;
an introduction cross-capillary channel formed in the substrate and extending across the plurality of capillary channels near the first common source, the introduction cross-capillary channel comprising transverse portions connecting adjacent ones of the capillary channels and coinciding portions that coincide with portions of the capillary channels to impart a generally serpentine configuration to the introduction cross-capillary channel;
a collection cross-capillary channel formed in the substrate and extending across the plurality of capillary channels near the second common source, the collection cross-capillary channel comprising transverse portions connecting adjacent ones of the capillary channels and coinciding portions that coincide with portions of the capillary channels to impart a generally serpentine configuration to the collection cross-capillary channel;
a second analyte movement subsystem operative to move analyte along the introduction cross-capillary channel; and
a third analyte movement subsystem operative to move analyte along the collection cross-capillary channel.

2. The system of claim 1, wherein the first common source and the second common source each comprise a source capillary channel extending transversely to the plurality of capillary channels.

3. The system of claim 2, wherein each of the source capillary channels further includes buffer reservoirs at opposed ends.

4. The system of claim 1, wherein the first analyte movement subsystem comprises an electrophoresis assembly operative to provide a voltage differential across the capillary channels.

5. The system of claim 4, wherein the electrophoresis assembly comprises electrodes disposed at the first and second common sources.

6. The system of claim 1, wherein the first analyte movement subsystem comprises a vacuum source operative to apply a vacuum to the plurality of capillary channels.

7. The system of claim 1, wherein the first analyte movement subsystem comprises a pressure differential source operative to apply a pressure differential across the plurality of capillary channels.

8. The system of claim 1, wherein the second analyte movement subsystem comprises an electrophoresis assembly operative to provide a voltage differential across the introduction cross-capillary channel.

9. The system of claim 8, wherein the electrophoresis assembly comprises electrodes disposed at opposed ends of the introduction cross-capillary channel.

10. The system of claim 1, wherein the second analyte movement subsystem comprises a vacuum source operative to apply a vacuum to the introduction cross-capillary channel.

11. The system of claim 1, wherein the second analyte movement subsystem comprises a pressure source operative to apply a pressure differential across the introduction cross-capillary channel.

12. The system of claim 1, wherein the introduction cross-capillary channel has at one end a first reservoir and at the other end a second reservoir.

13. The system of claim 12, wherein electrodes are disposed within the first and second reservoirs of the introduction cross-capillary channel.

14. The system of claim 1, wherein the second analyte movement subsystem is operative to move target along the introduction cross-capillary channel.

15. The system of claim 1, wherein the third analyte movement subsystem comprises an electrophoresis assembly operative to provide a voltage differential across the collection cross-capillary channel.

16. The system of claim 15, wherein the electrophoresis assembly comprises electrodes disposed at opposed ends of the collection cross-capillary channel.

17. The system of claim 1, wherein the third analyte movement subsystem comprises a vacuum source operative to apply a vacuum to the collection cross-capillary channel.

18. The system of claim 1, wherein the third analyte movement subsystem comprises a pressure source operative to apply a pressure differential across the collection cross-capillary channel.

19. The system of claim 1, wherein the collection cross-capillary channel has at one end a first reservoir and at the other end a second reservoir.

20. The system of claim 1, wherein electrodes are disposed within the first and second reservoirs in collection cross-capillary channel.

21. The system of claim 1, wherein the third analyte movement subsystem is operative to move target/ligand complex along the collection cross-capillary channel.

22. The system of claim 1, wherein the substrate is covered with a further substrate.

23. The system of claim 1, wherein the plurality of capillary channels, the introduction cross-capillary channel, and the collection cross-capillary channel are formed in a surface of the substrate.

24. The system of claim 1, wherein the plurality of capillary channels comprises at least two capillary channels.

25. The system of claim 1, wherein each of the plurality of capillary channels has a length between the introduction cross-capillary channel and the collection cross-capillary channel of at least 2 cm.

26. The system of claim 4, 8 and 15, wherein the electrophoresis assembly further comprises a power supply operative to supply at least 0.5 kV.

27. The system of claim 1, wherein the system further comprises a detection element operative to detect presence of a desired protein/ligand complex at the collection cross-capillary channel.

28. The system of claim 27, wherein the detection element comprises on-line laser induced fluorescence or ultraviolet detector.

29. A method of obtaining ligands from natural samples, the method comprising the steps of:
(a) providing the system of claim 1;
(b) adding a buffer containing natural sample in one of the first and second common sources;
(c) actuating the first analyte movement subsystem to fill the entire plurality of capillary channels with the buffer;
(d) deactuating the first analyte movement subsystem;
(e) adding target to the introduction cross-capillary channel;
(f) actuating the second analyte movement subsystem to fill the entire introductory cross-capillary channel with target;
(g) deactuating the second analyte movement subsystem;
(h) adding a buffer containing natural sample in either one of the first and second common sources, whichever was not filled in (b);
(i) actuating the first analyte movement subsystem to cause the target to migrate across to the collection cross-capillary channel and to bind the target with the natural sample, wherein such binding produces a target/ligand complex;
(j) deactuating the first analyte movement subsystem when the target/ligand complex is within the collection cross-capillary channel; and
(k) actuating the third analyte movement subsystem to collect the target/ligand complex.

30. The method of claim 29, wherein step (d) further comprising subsequently filling the other of the first and second common sources.

31. The method of claim 29, further comprising the step of analyzing the target/ligand complex.

32. The method of claim 31, wherein the analyzing step comprises identification.

33. The method of claim 31, wherein the analyzing step comprises quantification.

34. A method of obtaining ligands from natural samples, the method comprising the steps of:
(a) providing the system of claim 1;
(b) actuating the first analyte movement subsystem to fill the plurality of capillary channels with a buffer containing natural sample;
(c) actuating the second analyte movement subsystem to fill the introduction cross-capillary channel with a target;
(d) actuating the first analyte movement subsystem to cause the target to migrate along the plurality of capillary channels to the collection cross-capillary channel and to bind the target with the natural sample, wherein such binding produces a target/ligand complex;
(e) detecting the presence of the target/ligand complex at the collection cross-capillary channel; and
(f) actuating the third analyte movement subsystem to collect the target/ligand complex.

35. A microscale affinity purification system comprising:
a substrate;
a longitudinally extending capillary channel formed in the substrate, the capillary channel connected at one end to a first source of buffer and connected at an opposite end to a second source of buffer;
a first analyte movement subsystem operative to move analyte along the capillary channel from a first reservoir to a second reservoir or from the second reservoir to the first reservoir;
an introduction cross-capillary channel formed in the substrate and extending across the capillary channel near the first reservoir, at least a portion of the introduction cross-capillary channel comprising a coinciding portion that coincides with a portion of the capillary channel;
a target source in analyte communication with the introduction cross-capillary channel;
a target reservoir in analyte communication with the capillary channel to receive excess target;
a collection cross-capillary channel formed in the substrate and extending across the capillary channel near the second reservoir, at least a portion of the collection cross-capillary channel comprising a coinciding portion that coincides with a portion of the capillary channel;
a buffer source in analyte communication with the collection cross-capillary channel;
a collection reservoir in analyte communication with the collection channel to receive target/ligand complex;
a second analyte movement subsystem operative to move analyte along the introduction cross-capillary channel; and
a third analyte movement subsystem operative to move analyte along the collection cross-capillary channel.

36. The system of claim 35, wherein said first, second and third analyte movement subsystem comprises an electrophoresis assembly operative to provide voltage differential across the capillary channels.

37. The system of claim 36, wherein the electrophoresis assembly comprises electrodes disposed at the opposite ends of the capillary channel, the introduction cross-capillary channel and the collection cross-capillary channel.
